(19) United States
(12) Patent Application Publication
(10) Pub. No.: US 2022/0111532 A1
(43) Pub. Date: Apr. 14, 2022

(54) INTEGRITY AND SAFETY CHECKING FOR ROBOTS

(71) Applicant: Intel Corporation, Santa Clara, CA (US)

(72) Inventors: Norbert STOEFFLER, Graefeling (DE); Yang PENG, Munich (DE)

(21) Appl. No.: 17/557,053

(22) Filed: Dec. 21, 2021

(51) Int. Cl. B25J 9/16

(52) U.S. Cl. CPC B25J 9/1697; B25J 9/1664

(57) ABSTRACT

A device may include a processor. The processor may receive sensor data representative of an environment comprising a robot. The processor may extract features from the sensor data to generate an extracted feature set indicating an observation of the robot within the environment. The processor may generate a feature set indicating an expected observation of the robot within the environment based on pre-defined parameters of the robot. The processor may determine a difference between the observation and the expected observation of the robot. The processor may determine a systemic failure based on the difference between the observation and the expected observation of the robot exceeding a threshold value. The processor may instruct the robot to transition to a non-operative state responsive to the systemic failure being determined.

### FIELD

The aspects discussed in the present disclosure are related to integrity and safety checking for robots.

### BACKGROUND

Unless otherwise indicated in the present disclosure, the materials described in the present disclosure are not prior art to the claims in the present application and are not admitted to be prior art by inclusion in this section.

Autonomous robots are becoming increasingly widespread in work and personal environments. As the number of robots in such environments increases, so does the risk of hazardous interactions among robots and humans in shared spaces. Due to their size and cost, many robots may have limited sensing, processing, and decision-making capabilities, which means that in addition to internal systems, they may rely on external sensors, external systems, or external processing to operate safely. Each of these locations may introduce a number of potential failure points—on the robot, on an external system, or in communications among them—that could create critical failures in a robot's operation. In turn, this may have safety-critical impact to the environment, especially in environments where robots operate nearby other objects or even humans.

The subject matter claimed in the present disclosure is not limited to aspects that solve any disadvantages or that operate only in environments such as those described above. Rather, this background is only provided to illustrate one example technology area where some aspects described in the present disclosure may be practiced.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 illustrates an exemplary robot system that includes an integrity-checking system for checking the system integrity of a robot;

FIG. 2 illustrates an exemplary operational environment to perform integrity checking of the robot;

FIG. 3 illustrates another exemplary operational environment to perform integrity checking of the robot;

FIG. 4 illustrates yet another exemplary operational environment to perform integrity checking of the robot;

FIG. 5A depicts a robot for a robot system that may utilize optic flow;

FIG. 5B depicts a robot for a robot system that may use a ground window for integrity-checking;

FIG. 6 illustrates a schematic drawing for a device that checks the system integrity of a robot system; and

FIG. 7 illustrates a flow diagram of an exemplary method to determine a systemic failure, all according to at least one aspect described in the present disclosure.

### DETAILED DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “robot” may be understood to include any type of digitally controllable machine that is designed to perform a task or tasks. By way of example, a robot may be an autonomous mobile robot (AMR) that may move within an area (e.g., a manufacturing floor, an office building, a warehouse, etc.) to perform a task or tasks; or a robot may be understood as an automated machine with arms, tools, and/or sensors that may perform a task or tasks at a fixed location; or a combination thereof. Reference is made herein to a “environment” as any area in which a robot may be located or to which it may move in order to perform tasks. As should be appreciated, an “environment” is meant to encompass any area, including, for example, a room, multiple rooms, an air duct, a plurality of air ducts, an entire floor of a building, multiple floors of a building, an entire building, multiple buildings, a factory, an airport, a shopping mall, an outdoor area, a train station, a bus terminal, etc.

As robots operate in an environment where other objects, and especially humans are also present, robots (e.g., cobots) may be considered safety-critical in terms of functional safety (FuSa). This may be true for mobile robots that may be moving around a crowded environment (e.g., a dynamic environment), and it may also be true for robots that are stationary, performing set stationary movements (e.g., with a robotic arm) to accomplish tasks in the crowded environment. In both cases, the risk to humans may increase when robots are collaborating with humans in performing their tasks. To perform their tasks, robots may utilize a number of subsystems, including, for example, a sensor subsystem with numerous sensors, which may include simple positioning sensors, more complex ultra-sonic distance sensors, and even more powerful depth camera systems. The sensors may permit the robot to understand and interpret the environment to perform the tasks. For example, the sensors may permit the robot to detect and avoid a static object (e.g., a building, a rack, a work station, etc.) or avoid a mobile object (e.g., a mobile robot, a human, a lift truck, debris, a vehicle, etc.).

These sensors may be distributed among a number of communicatively-connected locations, including on robot itself, on part of the stationary infrastructure, or on other objects/robots in the environment. To ensure safe operation, a robot may employ an integrity-checking system to monitor each subsystem. This is particularly true for the sensor subsystem because sensors are often the robot's main source of perceiving the physical environment around it. As a result, the integrity-checking system may monitor the integrity of its sensor processing pipeline. For example, the integrity-checking system may cause the robot to operate according to American national standards institute (ANSI)/robotic industries association (RIA) R15.08.-1-2-2-industrial mobile robots (IMR) safety requirements.

The common way to ensure that all subsystems are working properly is for an integrity-checking system to use redundancy. Double redundancy is a case in which the subsystem includes a redundant counterpart of a given component, and the integrity-checking system compares the output of the component with the output of the redundant counterpart. If there is a mismatch, the integrity-checking system may determine that a failure has occurred. For sensor processing, duplicate processing pipelines (e.g., redundant sensor hardware, redundant sensor fusion processing, redundant communications paths, etc.) may be added, in which the integrity-checking system then compares the outputs of both pipelines and identifies data differences to detect failures. Redundancy, however, may require adding numerous components to the overall robot system, and it is therefore an expensive way of detecting failures. In addition, redundancy may not be able to detect errors in cases where the robot has stopped moving, the communication pipeline is frozen, the mechanical actuators of the robot have jammed, the robot's motion is repetitive, or if a malicious attacker has infiltrated the redundancy system to fabricate a match. Each of these potential problems may be a significant weakness in integrity-checking system based on redundancy.

By contrast to redundancy, the integrity-checking system described in the present disclosure may provide for system integrity checking without using redundancy and the associated added costs. The integrity checking system described in the present disclosure may monitor the sensors, operation of the robot (e.g., joint/motor control), the processing pipeline, or some combination thereof. The integrity checking system may compare features extracted from images representative of actual movements of the robot to predicted movements of the robot to perform the integrity monitoring. The comparison of the actual movements to the predicted movements of the robot may reduce a number of sensors included in the robot.

The integrity checking system may receive sensor data representative of an environment that includes the robot. The integrity checking system may also extract features from the sensor data. In addition, the integrity checking system may generate an extracted feature set indicating an observation of the robot within the environment. Further, the integrity checking system may generate a feature set indicating an expected observation of the robot within the environment. The feature set may be generated based on pre-defined parameters of the robot. The integrity checking system may determine a difference between the observation and the expected observation of the robot. The integrity checking system may determine a systemic failure based on the difference between the observation and the expected observation of the robot exceeding a threshold value. In addition, the integrity checking system may instruct the robot to transition to a non-operative state responsive to the systemic failure being determined.

Advantageously, such integrity checking may schedule checks to occur by time, task, use case, environment, etc., depending on the safety needs of the environment. In addition, by removing the redundancy, the disclosed integrity-checking system may include a reduced number of components (and associated costs). In addition, the disclosed integrity-checking system may be able to monitor the entire sensor subsystem (e.g., sensor hardware, sensor processing, motion control, mechanical actuators on the robot, the communication channels for transmitting information among the distributed system, etc.) rather than just discrete portions, as would be the case with a redundancy-based system. As such, a single integrity check may check a larger portion of the robot's system.

The integrity checking system may monitor subparts of the processing pipeline. The integrity checking system may detect a frozen camera, frozen image capturing pipeline, a faulty joint control, a mechanical failure, or some combination thereof. In addition, the integrity checking system may be implemented for a static robot that moves a limb within the environment or a mobile robot that moves within the environment either without or also moving a limb within the environment. The integrity checking system may reduce a cost associated with the robot, while monitoring the integrity of the entire processing pipeline of the robot.

These and other aspects of the present disclosure will be explained with reference to the accompanying figures. It is to be understood that the figures are diagrammatic and schematic representations of such example aspects, and are not limiting, nor are they necessarily drawn to scale. In the figures, features with like numbers indicate like structure and function unless described otherwise.

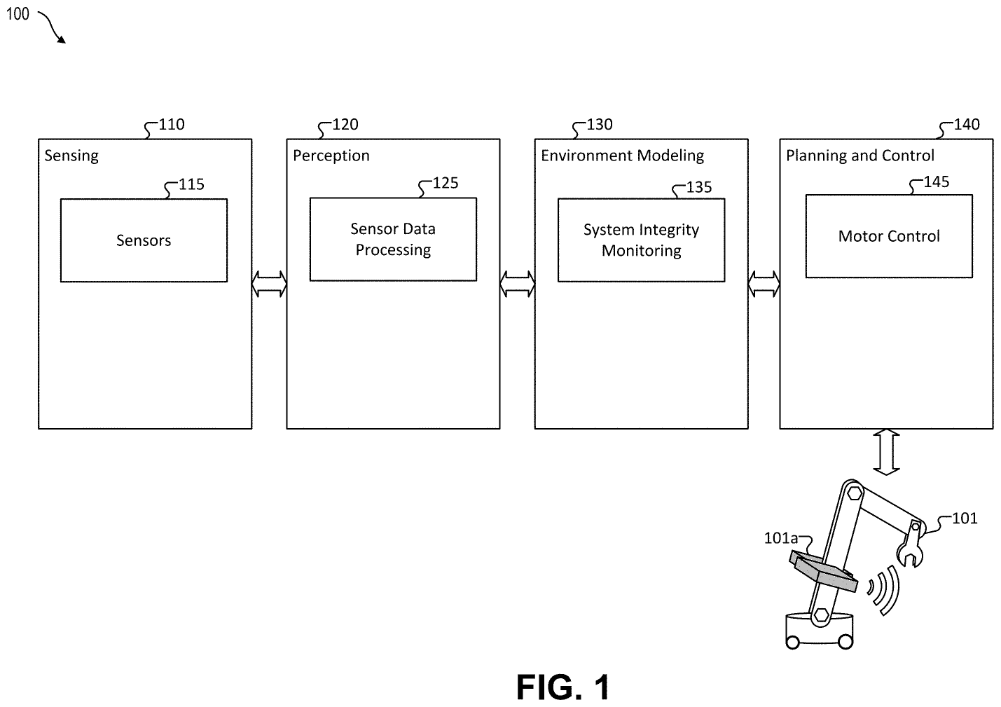

FIG. 1 illustrates a robot system 100 that includes an improved integrity-checking system for checking the system integrity of a robot (e.g., robot 101). Robot system 100 may include a number of subsystems that may be distributed across numerous locations, including, for example, on the robot itself, on an edge or cloud-based server, on other robots, on infrastructure equipment, etc. Alternatively, all of the subsystems of the robot system 100 may be physically located on the robot 101.

Robot system 100 may include receivers, transmitters, and/or transceivers (e.g., a wireless modem) (not illustrated in FIG. 1) for communicating information among the distributed processing locations. Robot system 100 may also store system information (e.g., sensor data, localization data, object data, perception data, environmental modeling data, planning data, motion control data, program instructions, etc.) in a memory (not illustrated in FIG. 1) to facilitate storage and transfer of the information. Robot system 100 may include a sensing system 110 (which may utilize sensor data from any number of sensors 115 (e.g., cameras, depth sensors, motion detectors, light ranging and detection (LiDAR) sensors, radar sensors, infrared sensors, etc.), a perception system 120, an environment modeling system 130, a planning and control system 140, and a communications system (not illustrated in FIG. 1) for communicating among these various subsystems. Each of these systems (and their underlying components and subsystems) may potentially be a source of error in the overall operation of the robot 101.

To perform an integrity check, the integrity-checking system of robot system 100 may include a system integrity monitoring module 135. The system integrity monitoring module 135 is illustrated in FIG. 1 within the environment modelling system 130 for example purposes.

The robot system 100 may transmit (e.g., via a transmitter that is part of its communication system) a work task to the robot 101 for execution. For example, the work task may include a locomotion instruction to cause the robot 101 to move to another location within the environment. As another example, the work task may include a limb control instruction to cause the robot 101 to pick and place an object. The planning and control system 140 may include a motor control 145 configured to control one or more joints or motors within the robot 101. The motor control 145 may cause the robot 101 to operate according to the work task.

The sensors 115 may capture sensor data representative of the environment including the robot 101. The sensors may include on-robot sensors that are part of a sensing and processing module 101a, external sensors that are physically located away from the robot 101, or some combination thereof. The sensor data processing 125 may extract features from the sensor data. For example, the sensor data processing 125 may extract object features, object tracking features, free space features, sensor monitoring features, edge features, color features, optic flow features (e.g., optic flow vectors), motion features, or some combination thereof using the sensor data. The sensor data processing 125 may generate an extracted feature set based on the extracted features. The extracted feature set may indicate an observation of the robot 101 within the environment (e.g., an actual location of at least a part of the robot 101).

The system integrity monitoring module 135 may receive the extracted feature set. The system integrity monitoring module 135 may generate a feature set. The feature set may indicate an expected observation of the robot 101 within the environment. The feature set may be generated based on pre-defined parameters of the robot. The system integrity monitoring module 135 may generate the feature set using expected contents of the sensor data when the work task is actually executed by the robot 101, using, for example, the environment modeling system 130.

The system integrity monitoring module 135 may determine a difference between the observation and the expected observation of the robot 101. For example, the system integrity monitoring module 135 may compare the feature set to the extracted feature set. If a difference between the feature set and the extracted feature set exceeds a predefined threshold, the system integrity monitoring module 135 may determine a fault exists in the robot system 100 (e.g., a systemic failure). The systemic failure may include an intermittent failure, a permanent failure, or some combination thereof. An example intermittent failure may include a bit being flipped in a random-access memory of the robot system 100. The robot system 100 may instruct the robot 101 to transition to a non-operative state responsive to the system failure being determined. Thus, the system integrity system may detect errors in the sensors 115, a joint controller (not illustrated in FIG. 1) of the robot 101, the robot 101 itself, or some combination thereof.

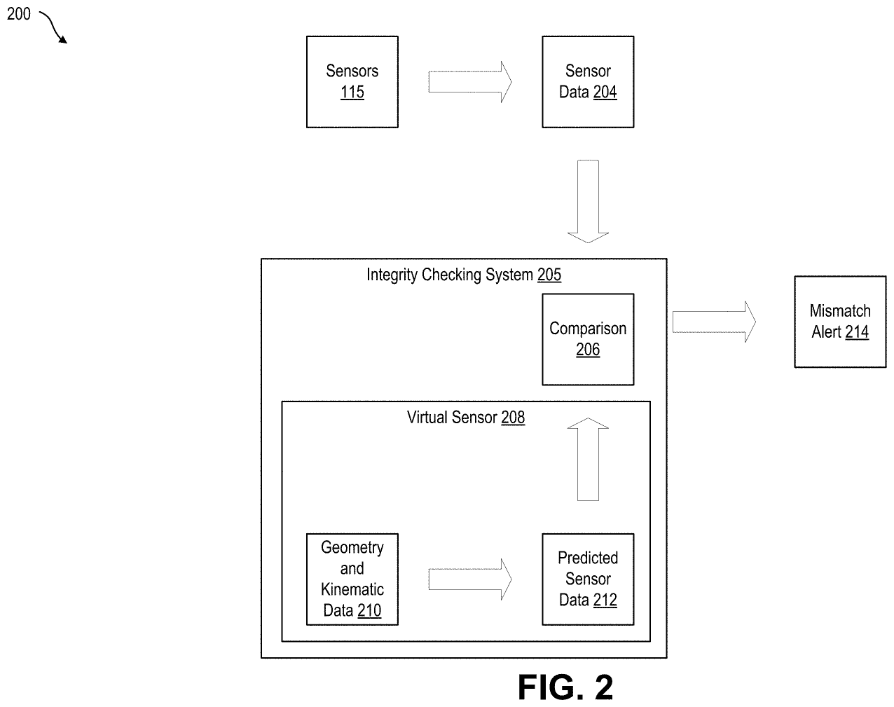

FIG. 2 illustrates an exemplary operational environment 200 to perform integrity checking of the robot, in accordance with at least one aspect described in the present disclosure. The operational environment 200 may include sensors 115 and an integrity checking system 205. The integrity checking system 205 may include a virtual sensor 208. The integrity checking system 205 may correspond to the system integrity module 135 of FIG. 1.

The sensors 115 may capture sensor data 204 representative of the environment of the robot (e.g., robot 101 of FIG. 1). The sensor data 204 may represent an observation of the robot in the environment.

The virtual sensor 208 may receive geometry and kinematic data 210. The geometry and kinematic data 210 may include a pre-defined kinematic parameter, a pre-defined geometric parameter, a determined kinematic parameter, or some combination thereof of the robot. The determined kinematic parameter may include a joint state of one or more joints of the robot, a motor speed state of one or more motors of the robot, or some combination thereof. The virtual sensor 208 or the integrity checking system 205 may receive the determined kinematic data from a motor control (e.g., motor control 125 of FIG. 1). Alternatively, the virtual sensor 208 or the integrity checking system 205 may determine the determined kinematic data based on information received from the motor control. The geometry and kinematic data 210 may be extracted from a user manual, a data manual, or other information directed to the robot.

The virtual sensor 208 may generate predicted sensor data 212 based on the geometry and kinematic data 210. The predicted sensor data 212 may be representative of a predicted or expected observation of the robot. The integrity checking system 205 may compare the sensor data 204 to the predicted sensor data 212 to determine if there is difference. For example, the integrity checking system 205 may compare the observation of the robot to the expected observation of the robot to determine if there is a difference in an actual position of the robot versus an expected position of the robot.

Responsive to a difference between the predicted sensor data 212 and the sensor data 204 exceeding a threshold value, the integrity checking system 205 may generate a mismatch alert 214. The mismatch alert 214 may include an instruction to the robot to transition to a non-operative state.

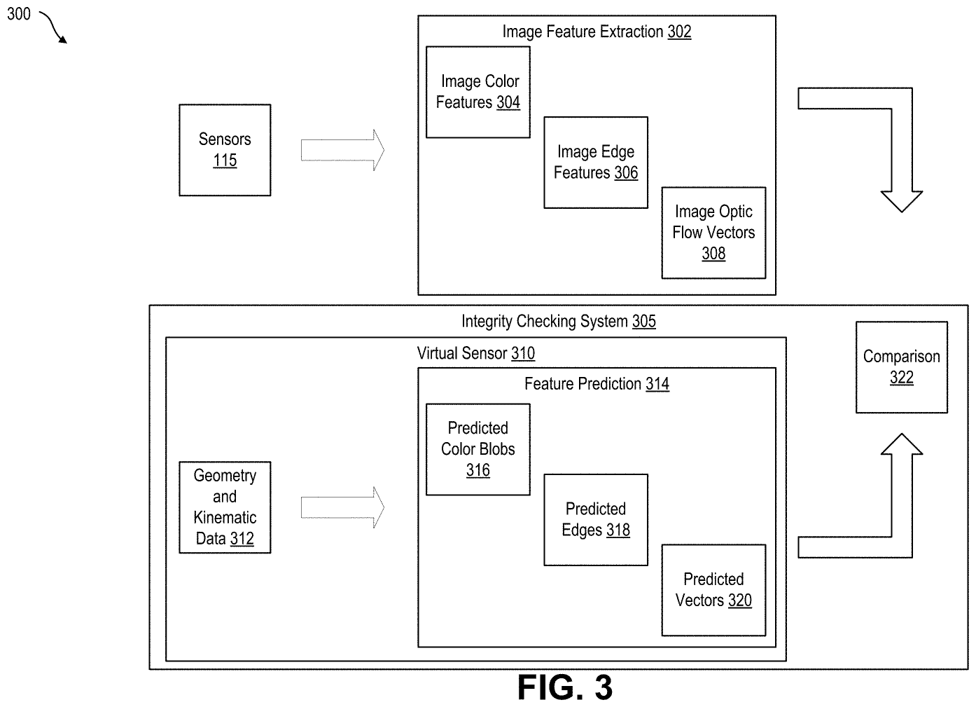

FIG. 3 illustrates another exemplary operational environment 300 to perform integrity checking of the robot, in accordance with at least one aspect described in the present disclosure. The operational environment 300 may include the sensors 115, an image feature extraction 302, and an integrity checking system 305. The integrity checking system 305 may include a virtual sensor 310. The integrity checking system 305 may correspond to the system integrity module 135 of FIG. 1 or the integrity checking system 205 of FIG. 2. The image feature extraction 302 may correspond to the sensor data processing system 125 of FIG. 1.

The sensors 115 may capture sensor data representative of the environment of the robot (e.g., robot 101 of FIG. 1). The sensor data may represent an observation of the robot in the environment. The image feature extraction 302 may receive the sensor data. The image feature extraction 302 may extract features from the sensor data. For example, the image feature extraction 302 may extract image color features 304 of the robot in the environment. As another example, the image feature extraction 302 may extract image edge features 306 of the robot in the environment. As yet another example, the image feature extraction 302 may extract image optic flow vectors 308 of the robot, the environment, or some combination thereof. The image feature extraction 302 may extract the image color features 304, the image edge features 306, the image optic flow vectors 308, or some combination thereof. The image optic flow vectors 308 may include optic flow vectors representative of movement of the robot relative the environment.

The virtual sensor 310 may include a feature prediction 314. The feature prediction 314 may receive geometry and kinematic data 312. The geometry and kinematic data 312 may include a pre-defined kinematic parameter, a pre-defined geometric parameter, a determined kinematic parameter, or some combination thereof. The determined kinematic parameter may include a joint state of one or more joints of the robot, a motor speed state of one or more motors of the robot, or some combination thereof. The virtual sensor 310 or the integrity checking system 305 may receive the determined kinematic data from a motor control (e.g., motor control 125 of FIG. 1). Alternatively, the virtual sensor 310 or the integrity checking system 305 may determine the determined kinematic data based on information received from the motor control. The geometry and kinematic data 312 may be extracted from a user manual, a data manual, or other information directed to the robot.

The feature prediction 314 may predict features of the robot, the environment, or some combination thereof. For example, the feature prediction 314 may generate predicted color blobs 316 of the robot. As another example, the feature prediction 314 may generate predicted edges 318 of the robot. As yet another example, the feature prediction 314 may generate predicted vectors 320 (e.g., predicated optic flow vectors) of the robot, the environment, or some combination thereof.

The integrity checking system 305 may compare 322 the extracted features (e.g., the image color features 304, the image edge features 306, the image optic flow vectors 308, or some combination thereof) to the predicted features (e.g., the predicted color blobs 316, the predicted edges 318, the predicted vectors 320, or some combination thereof). For example, the integrity checking system 305 may compare the image color feature 304 to the predicted color blobs 316. As yet another example, the integrity checking system 305 may compare the image edge features 306 to the predicted edges 318. As yet another example, the integrity checking system 305 may compare the image optic flow vectors 308 to the predicted vectors 320. The integrity checking system 305 may compare the extracted features to the predicted features to determine a difference in an actual position of the robot versus an expected position of the robot. If the comparison reveals differences (e.g., that exceed a predefined threshold), the integrity checking system 305 may determine that a fault exists.

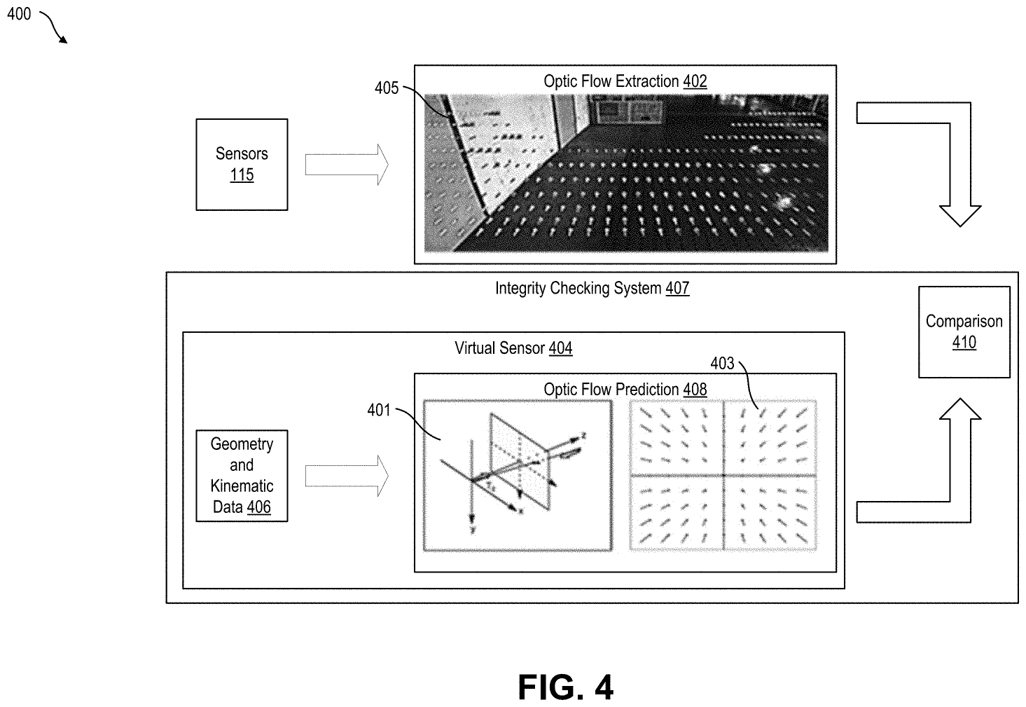

FIG. 4 illustrates yet another exemplary operational environment 400 to perform integrity checking of the robot, in accordance with at least one aspect described in the present disclosure. The operational environment 400 may include the sensors 115, an optic flow extraction 402, and an integrity checking system 407. The integrity checking system 407 may include a virtual sensor 404. The integrity checking system 407 may correspond to the integrity module 135 of FIG. 1, the integrity checking system 205 of FIG. 2, or the integrity checking system 305 of FIG. 3. The optic flow extraction 402 may correspond to the sensor data processing 125 of FIG. 1. The sensors 115 may be physically positioned proximate a surface of the robot. For example, the sensors 115 may be positioned such that the sensors physically contact an external surface of the robot. As another example, the sensors 115 may be physically attached to the robot such that the sensors 115 move when the robot moves. The robot may include a mobile robot. The optic flow feature 402 may represent an exact scene of the environment, the robot, or some combination thereof.

The sensors 115 may capture sensor data representative of the environment of the robot (e.g., robot 101 of FIG. 1). The sensor data may represent an observation of the robot in the environment. The optic flow extraction 402 may receive the sensor data. The optic flow extraction 402 may measure the optic flow associated with the sensor data to obtain a measured optic flow field 405 (e.g., a field of optic flow vectors). The optic flow field 405 may be used to solve for motion and depth (e.g., as part of a simultaneous localization and motion (SLAM) routine that is performed by an environment modeling system (e.g., the environment modeling system 130 of FIG. 1)).

Generally, optic flow refers to a two-dimensional vector field that describes motion of individual points (e.g., pixels) in an image plane of images captured by a camera. The optic flow extraction 402 may measure optic flow from an image sequence by a variety of well-known methods, such as by solving for local brightness constraints for every pixel in a sequence of images (e.g., dense flow) or by tracking individual feature points in a sequence of images (e.g., sparse flow).

The virtual sensor 404 may include an optic flow prediction 408. The optic flow prediction 408 may receive geometry and kinematic data 406. The geometry and kinematic data 406 may include a pre-defined kinematic parameter, a pre-defined geometric parameter, a determined kinematic parameter, or some combination thereof of the robot. The determined kinematic parameter may include a translation of the robot along a corresponding axis, a rotation of the robot along a corresponding axis, a joint state of one or more joints of the robot, a motor speed state of one or more motors of the robot, or some combination thereof. The virtual sensor 404 or the integrity checking system 407 may receive the determined kinematic data from a motor control (e.g., motor control 125 of FIG. 1). Alternatively, the virtual sensor 404 or the integrity checking system 407 may determine the determined kinematic data based on information received from the motor control. The geometry and kinematic data 406 may be extracted from a user manual, a data manual, or other information directed to the robot.

The optic flow prediction 408 may predict optic flow vectors of the robot, the environment, or some combination thereof. The optic flow prediction 408 may generate a predicted optic flow field 403 (e.g., a field of predicted optic flow vectors) relative the environment based on the geometry and kinematic data 406. In addition, the optic flow prediction 408 may generate a predicted motion field 401 relative the robot based on the geometry and kinematic data 406.

The optic flow prediction 408 may predict optic flow for the environment using the scene geometry and the camera motion, using, for example, Equation 1.

$$[ \begin{matrix}\dot{x} \\ \dot{y}\end{matrix} ] = \frac{1}{Z} [ \begin{matrix}{T}_{z} x - {T}_{x} \\ {T}_{z} y - {T}_{y}\end{matrix} ] + {ω}_{x} [ \begin{matrix}xy \\ {y}^{2} + 1\end{matrix} ] - {ω}_{y} [ \begin{matrix}{x}^{2} + 1 \\ xy\end{matrix} ] - {ω}_{z} [ \begin{matrix}- y \\ x\end{matrix} ] \qquad Equation 1$$

In Equation 1, T may represent a translation of the robot along a corresponding axis, ω may represent a rotation of the robot along a corresponding axis, Z may represent a distance between the sensor and a scene point within the environment, and x and y may represent two dimensional coordinates of a corresponding pixel for which the optic flow is calculated.

The integrity checking system 407 may compare 410 the measured optic flow field 405 with the predicted optic flow field 403. If the comparison reveals differences (e.g., that exceed a predefined threshold), the integrity checking system 407 may determine that a fault exists.

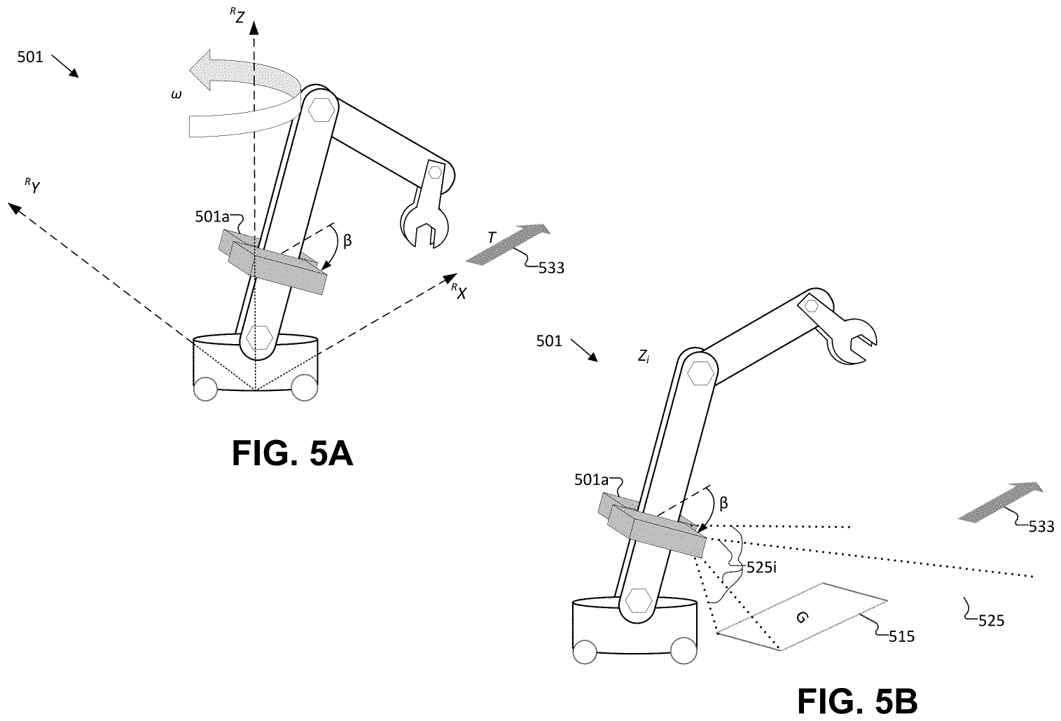

As exemplarily depicted in FIG. 5A, robot 501 may move within an environment according to a six-dimensional set of motion parameters (e.g., in robot coordinates, Tₓ, T_{y}, T_{z}, ωₓ, ω_{y}, ω₂). But because the robot 501 operates with knowledge of its own pose and trajectory 533 (T), the system may reduce the six-dimensional set of motion parameters to a one- or two-dimensional translation vector T and one rotational motion parameter around the Z-axis of robot 501. As such, the system may decompose the optic flow field into a first component that depends only on the translation vector T and scene depth, Z, and a second component that depends only on the rotation. Since the rotational component is completely independent from the scene geometry, the system may predict the rotational component from the robot's rotation speed, as known by the robot from its own operating parameters. Subtracting this predicted rotation from the measured optic flow results in a simplified optic flow field that depends only on the translation vector T and the scene depth, Z.

The integrity-checking system may then use a ground window to further simplify the optic flow field. The ground window may define an area along the trajectory of the robot that the integrity-checking system assumes to be free of obstacles. As shown in FIG. 5B, ground window 501 (also denoted as G) is an area along the trajectory 533 of robot 501 that the integrity-checking system assumes to be free of obstacles. Ideally, the integrity-checking system may define the ground window 501 by a width that is as least as wide as the physical width of the robot itself and a length that is at least as long as the safe-braking distance of the robot. Using this ground window and the camera angle relative to the ground plane (β), the integrity-checking system may calculate all scene depth values (Zᵢ), e.g., scene depth values 525i, for the ground plane 525, Z according to Equation 2.

$${Z}_{g} ( p ) = \frac{h}{cos β y + sin β} \qquad Equation 2$$

As a result, the integrity-checking system may predict the expected translational optic flow field within the ground plane (e.g., ground plane 525) and compare it to the measured optic flow field. Though the integrity-checking system may use any number of methods to compare the predicted expected translational optic flow field to the measured optic flow field, one such method is to sum the Euclidian distances between every predicted vector and every corresponding measured vector, and then compare the sum to a predetermined threshold. If the sum exceeds the predetermined threshold, the integrity-checking system may determine that a fault exists in the robot system (e.g., a systemic failure) and stop or modify the operation of robot until the fault has been repaired. The systemic failure may include an intermittent failure, a permanent failure, or some combination thereof. An example intermittent failure may include a bit being flipped in a random-access memory of the robot system. This type of optic flow integrity-checking may be particularly advantageous because it may introduce only a relatively small computational overhead to the overall system because it is able to repurpose the already-calculated optic flow, that the system may have already calculated as part of, for example, a SLAM algorithm. If the robot system has already calculated the optic flow for other purposes, the robot system may additionally execute optic flow integrity-checking using relatively low-performance processors that may be located, for example inside the robot. Of course, as with other aspects of the robot's system and as noted above, the optic flow integrity-checking may be processed at any location in a distributed system.

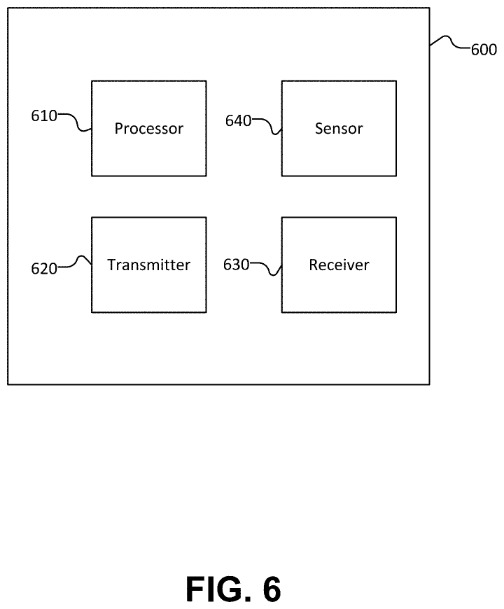

FIG. 6 is a schematic drawing illustrating a device 600 for checking the integrity of a robot system. The device 600 may include any of the features discussed with respect to robot system 100 and robot 101 of FIG. 1, robot 501 of FIGS. 5A and 5B, and flow diagram 400 of FIG. 4. FIG. 6 may be implemented as a device, a system, a method, and/or a computer readable medium that, when executed, performs the features of the safety systems described above. It should be understood that device 600 is only an example, and other configurations may be possible that include, for example, different components or additional components.

Device 600 includes a processor 610 configured to receive sensor data representative of an environment including a robot. In addition to or in combination with any of the features described in this or the following paragraphs, processor 610 is also configured to extract features from the sensor data to generate an extracted feature set indicating an observation of the robot within the environment. Further to or in combination with any of the features described in this or the following paragraphs, processor 610 is also configured to generate a feature set indicating an expected observation of the robot within the environment based on pre-defined parameters of the robot. In addition to or in combination with any of the features described in this or the following paragraphs, processor 610 is also configured to determine a difference between the observation and the expected observation of the robot. Further to or in combination with any of the features described in this or the following paragraphs, processor 610 is also configured to determine a systemic failure based on the difference between the observation and the expected observation of the robot exceeding a threshold value.

Furthermore, in addition to or in combination with any one of the features of this and/or the preceding paragraph, device 600 may further include a transmitter 620 configured to transmit an instruction to the robot to cause the robot to transition to a non-operative state responsive to the systemic failure being determined. Furthermore, in addition to or in combination with any one of the features of this and/or the preceding paragraph, device 600 may further include a receiver 630 configured to receive the received sensor data representative of the environment including the robot. Furthermore, in addition to or in combination with any one of the features of this and/or the preceding paragraph, the systemic failure may include a sensor failure of a sensor 640, wherein the receiver is configured to receive the sensor data from sensor 640, a manipulator failure in a manipulator of the robot, a processing failure of the processor 610 that is configured to determine the difference, or some combination thereof.

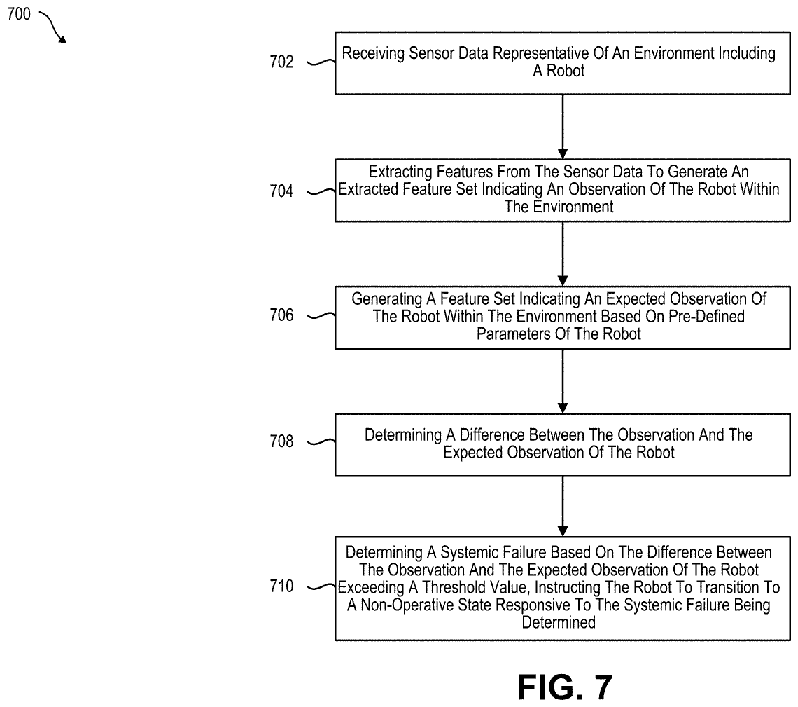

FIG. 7 illustrates a flow diagram of an exemplary method 700 to determine a systemic failure, in accordance with at least one aspect described in the present disclosure. The method 700 may include receiving sensor data representative of an environment including a robot 702; extracting features from the sensor data to generate an extracted feature set indicating an observation of the robot within the environment 704; generating a feature set indicating an expected observation of the robot within the environment based on pre-defined parameters of the robot 706; determining a difference between the observation and the expected observation of the robot 708; and determining a systemic failure based on the difference between the observation and the expected observation of the robot exceeding a threshold value, the operations further including instructing the robot to transition to a non-operative state responsive to the systemic failure being determined 710.

Modifications, additions, or omissions may be made to the method 700 without departing from the scope of the present disclosure. For example, the operations of method 700 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described aspects.

The integrity monitoring system may be implemented in FuSa applications. The integrity system may replace additional sensors (e.g., sensors for redundant processing) with scene prediction (e.g., a virtual sensor). The integrity monitoring system may predict and compare a portion of the environment. For example, the integrity monitoring system may compare a location of robot arm in a captured image to an expected location of the robot arm in a feature set. As another example, the integrity monitoring system may compare optic flow vectors of a floor of the environment to predicted optic flow vectors in a feature set.

The robot may be configured to operate according to safety standards intended to decrease a fault impact. The safety standard may establish diagnostic coverage for critical elements. The integrity monitoring system may compare an estimated environment (e.g., a simulated channel) with an actually observed environment (e.g., a perception of an output channel). The integrity monitoring system, based on the comparison, may determine a state of certain potentially safety-critical outputs.

The integrity monitoring system may detect a fault in any appropriate sensor that captures sensor data representative of at least a portion of the environment. The integrity monitoring system may be implemented for a static robot (e.g., a robot that is not mobile but moves a limb within the environment), a mobile robot (e.g., a robot that moves within the environment and may also move a limb within the environment), or some combination thereof.

The integrity monitoring system may receive sensor data. The integrity monitoring system may extract features from the sensor data. The system monitoring system may generate an extracted feature set using the extracted features. The extracted feature set may indicate an observed position of the robot within the environment.

The integrity monitoring system may determine expected three-dimensional positions of surfaces of the robot (e.g., a feature set). The integrity monitoring system may determine the expected positions of the surfaces based on a known geometry of the robot, kinematic abilities of the robot, current states of joints of the robot, or some combination thereof. The integrity monitoring system may also determine the expected positions of the surfaces based on known physical locations of the sensors relative the environment, the robot, or some combination thereof. The integrity monitoring system may compare the extracted feature set to the feature set.

The feature set may include predicted features and the extracted feature set may include the extracted features. The features may include color segmentation features, edge detection features, optic flow vectors, or some combination thereof. The extracted features may be compared to the predicted features. For example, for the color segmentation features, pixels that include the same or similar colors in the feature set and the extracted feature set may be identified by applying thresholds in a suitable color-space. The matching pixels may be combined into continuous regions using morphological operations or algorithms. For example, the integrity monitoring system may create a list of colored blobs associated with the robot in the extracted feature set and the colored blobs may be compared to the color blobs in the feature set.

For the edge detection features, the integrity monitoring system may extract edges of the robot from the sensor data. In addition, the integrity monitoring system may predict locations of the edges in the feature set. The predicted edge locations may be determined based on computer aided design (CAD) data directed to the robot. The integrity monitoring system may compare the extracted edges to the predicted edges.

For the optic flow vectors, the integrity monitoring system may transform the sensor data to a two-dimensional vector field that describes motion of individual pixels. In addition, the integrity monitoring system may generate a predicted vector field. The integrity monitoring system may compare the predicted vector field to the transformed two-dimensional vector field.

The integrity monitoring system may detect faults in a camera sensor, a sensor, the processing pipeline, pre-processing such as de-mosaicking and color space conversion of an image signal processor, a joint controller, mechanical actuators in the robot, or some combination thereof. In addition, the integrity monitoring system may detect faults even when the robot and environment are stationary (e.g., non-operational).

A device may include a processor that includes a system integrity monitoring module. The system integrity monitoring module may receive sensor data representative of an environment that includes the robot. The system integrity monitoring module may receive the sensor data from a sensor physically positioned away from the robot, a sensor physically positioned proximate an external surface of the robot, or some combination thereof. The sensor may include a depth sensor, a camera, a radar, a light ranging and detection sensor, an ultrasonic sensor, or some combination thereof.

The system integrity monitoring module may extract features from the sensor data. The system integrity monitoring module may generate an extracted feature set indicating an observation of the robot within the environment based on the extracted features. The extracted feature may include a color feature, an edge feature, a optic flow vector, or some combination thereof of the robot.

The system integrity monitoring module may generate a feature set indicating an expected observation of the robot within the environment. The feature set may be generated based on pre-defined parameters of the robot. The feature set may be further based on a feature of the robot extracted from the sensor data. For example, a state of the robot may be determined based on the extracted feature and the feature set may be further based on the state of the robot. The pre-defined parameters may include a kinematic parameter, a pre-defined geometric parameter, or some combination thereof of the robot. The system integrity monitoring module may determine the expected observation based on a normal expected motion pattern of the robot.

The system integrity monitoring module may determine an expected current state of a manipulator of the robot. The feature set may be further based on the expected current state of the manipulator of the robot. The system integrity monitoring module may determine a physical position of the sensor relative the robot based on a sensor parameter. The sensor parameter may include coordinates of the sensor within the environment, coordinates of the sensor on the robot, or some combination thereof. The feature set may be further based on the physical position of the sensor and the sensor parameter. They system integrity monitoring module may generate the feature set by determining an optic flow vector of the robot and the environment according to Equation 1.

The system integrity monitoring module may determine a difference between the observation and the expected observation of the robot. Responsive to a difference between the observation and the expected observation of the robot exceeding a threshold value, the system integrity monitoring module may determine a systemic failure has occurred and may instruct the robot to transition to a non-operative state. The systemic failure may include a sensor failure of a sensor that is configured to transmit the sensor data, a manipulator failure in a manipulator of the robot, a processing failure of an image processing pipeline that is configured to determine the difference between the observation and the expected observation of the robot, or some combination thereof. In addition, the systemic failure may include an intermittent failure, a permanent failure, or some combination thereof. An example intermittent failure may include a bit being flipped in a random-access memory of the robot.

The system integrity monitoring module may provide a fault message to an external device indicating a systemic failure has been detected. The device may include a transmitter communicatively coupled to the processor. The transmitter may transmit the fault message to the external device.

The system integrity monitoring module may cause the robot to operate according to an operative state based on the difference between the observation and the expected observation not exceeding the threshold value.

In the following, various examples are provided that may include one or more aspects described above with respect to the robot system 100 and the robot 101 of FIG. 1, the virtual sensor 208 of FIG. 2, the image feature extraction 302 and the virtual sensor 310 of FIG. 3, the optic flow extraction 402 and the virtual sensor 404 of FIG. 4, the robot 501 of FIGS. 5A and 5B, the device 600 of FIG. 6, and the method 700 of FIG. 7. The examples provided in relation to the devices may apply also to the described method(s), and vice versa.

Example 1 may include a device including a processor configured to: receive sensor data representative of an environment including a robot; extract features from the sensor data to generate an extracted feature set indicating an observation of the robot within the environment; generate a feature set indicating an expected observation of the robot within the environment based on pre-defined parameters of the robot; determine a difference between the observation and the expected observation of the robot; and determine a systemic failure based on the difference between the observation and the expected observation of the robot exceeding a threshold value, the processor is further configured to instruct the robot to transition to a non-operative state responsive to the systemic failure being determined.

Example 2 may include the device of example 1, wherein the processor is further configured to provide a fault message to an external device indicating a systemic failure has been detected responsive to the systemic failure being determined.

Example 3 may include the device of example 2, further including a transmitter communicatively coupled to the processor, the transmitter configured to transmit the fault message to the external device.

Example 4 may include the device of example 1, wherein the processor is further configured to cause the robot to operate according to an operative state based on the difference between the observation and the expected observation not exceeding the threshold value.

Example 5 may include the device of example 1, wherein the processor is configured to generate the feature set based on features that are extracted from the sensor data.

Example 6 may include the device of example 1, wherein the extracted features include at least one of a color feature, an edge feature, and an optic flow vector.

Example 7 may include the device of example 1, wherein: the pre-defined parameters of the robot include at least one of a kinematic parameter and a geometric parameter; and the processor is further configured to determine a current state of a manipulator of the robot, wherein the feature set is further based on the current state of the manipulator of the robot.

Example 8 may include the device of example 1, wherein: the processor is configured to receive the sensor data from a sensor physically positioned away from the robot; and the processor is further configured to determine a physical position of the sensor relative the robot based on a sensor parameter, wherein the feature set is further based on the physical position of the sensor and the sensor parameter.

Example 9 may include the device of example 1, wherein the processor is configured to: receive the sensor data from a sensor physically positioned proximate an external surface of the robot; and generate the feature set by determining an optic flow vector of at least one of the robot and the environment.

Example 10 may include the device of example 1, wherein the systemic failure includes at least one of a sensor failure of a sensor that is configured to transmit the sensor data, a manipulator failure in a manipulator of the robot, and a processing failure of an image processing pipeline that is configured to determine the difference between the observation and the expected observation of the robot.

Example 11 may include the device of example 1, wherein: the processor is configured to receive the sensor data from a sensor physically positioned away from the robot; and the sensor includes at least one of a depth sensor, a camera, a radar, a light ranging and detection sensor, or an ultrasonic sensor.

Example 12 may include the device of example 1, wherein the processor is configured to determine the expected observation based on a normal expected motion pattern of the robot.

Example 13 may include a non-transitory computer-readable medium including: a memory having computer-readable instructions stored thereon; and a processor operatively coupled to the memory and configured to read and execute the computer-readable instructions to perform or control performance of operations including: receiving sensor data representative of an environment including a robot; extracting features from the sensor data to generate an extracted feature set indicating an observation of the robot within the environment; generating a feature set indicating an expected observation of the robot within the environment based on pre-defined parameters of the robot; determining a difference between the observation and the expected observation of the robot; and determining a systemic failure based on the difference between the observation and the expected observation of the robot exceeding a threshold value, the operations further including instructing the robot to transition to a non-operative state responsive to the systemic failure being determined.

Example 14 may include the non-transitory computer-readable medium of example 13, the operations further including providing a fault message to an external device indicating a systemic failure has been detected responsive to the systemic failure being determined.

Example 15 may include the non-transitory computer-readable medium of example 14, the operations further including transmitting the fault message to the external device.

Example 16 may include the non-transitory computer-readable medium of example 13, the operations further including causing the robot to operate according to an operative state based on the difference between the observation and the expected observation not exceeding the threshold value.

Example 17 may include a system, including: means to receive sensor data representative of an environment including a robot; means to extract features from the sensor data to generate an extracted feature set indicating an observation of the robot within the environment; means to generate a feature set indicating an expected observation of the robot within the environment based on pre-defined parameters of the robot; means to determine a difference between the observation and the expected observation of the robot; and means to determine a systemic failure based on the difference between the observation and the expected observation of the robot exceeding a threshold value, the system further including means to instruct the robot to transition to a non-operative state responsive to the systemic failure being determined.

Example 18 may include the system of example 17 further including means to provide a fault message to an external device indicating a systemic failure has been detected responsive to the systemic failure being determined.

Example 19 may include the system of example 18 further including means to transmit the fault message to the external device.

Example 20 may include the system of example 17 further including means to cause the robot to operate according to an operative state based on the difference between the observation and the expected observation not exceeding the threshold value.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. A device comprising a processor configured to:
receive sensor data representative of an environment comprising a robot;
extract features from the sensor data to generate an extracted feature set indicating an observation of the robot within the environment;
generate a feature set indicating an expected observation of the robot within the environment based on pre-defined parameters of the robot;
determine a difference between the observation and the expected observation of the robot; and
determine a systemic failure based on the difference between the observation and the expected observation of the robot exceeding a threshold value, the processor is further configured to instruct the robot to transition to a non-operative state responsive to the systemic failure being determined.

2. The device of claim 1, wherein the processor is further configured to provide a fault message to an external device indicating a systemic failure has been detected responsive to the systemic failure being determined.

3. The device of claim 2, further comprising a transmitter communicatively coupled to the processor, the transmitter configured to transmit the fault message to the external device.

4. The device of claim 1, wherein the processor is further configured to cause the robot to operate according to an operative state based on the difference between the observation and the expected observation not exceeding the threshold value.

5. The device of claim 1, wherein the processor is configured to generate the feature set based on features that are extracted from the sensor data.

6. The device of claim 1, wherein the extracted features comprise at least one of a color feature, an edge feature, and an optic flow vectors.

7. The device of claim 1, wherein:
the pre-defined parameters of the robot comprise at least one of a kinematic parameter and a geometric parameter; and
the processor is further configured to determine a current state of a manipulator of the robot, wherein the feature set is further based on the current state of the manipulator of the robot.

8. The device of claim 1, wherein:
the processor is configured to receive the sensor data from a sensor physically positioned away from the robot; and
the processor is further configured to determine a physical position of the sensor relative the robot based on a sensor parameter, wherein the feature set is further based on the physical position of the sensor and the sensor parameter.

9. The device of claim 1, wherein the processor is configured to:
receive the sensor data from a sensor physically positioned proximate an external surface of the robot; and
generate the feature set by determining an optic flow vector of at least one of the robot and the environment.

10. The device of claim 1, wherein the systemic failure comprises at least one of a sensor failure of a sensor that is configured to transmit the sensor data, a manipulator failure in a manipulator of the robot, and a processing failure of an image processing pipeline that is configured to determine the difference between the observation and the expected observation of the robot.

11. The device of claim 1, wherein:
the processor is configured to receive the sensor data from a sensor physically positioned away from the robot; and
the sensor comprises at least one of a depth sensor, a camera, a radar, a light ranging and detection sensor, or an ultrasonic sensor.

12. The device of claim 1, wherein the processor is configured to determine the expected observation based on a normal expected motion pattern of the robot.

13. A non-transitory computer-readable medium comprising:
a memory having computer-readable instructions stored thereon; and
a processor operatively coupled to the memory and configured to read and execute the computer-readable instructions to perform or control performance of operations comprising:
receiving sensor data representative of an environment comprising a robot;
extracting features from the sensor data to generate an extracted feature set indicating an observation of the robot within the environment;
generating a feature set indicating an expected observation of the robot within the environment based on pre-defined parameters of the robot;
determining a difference between the observation and the expected observation of the robot; and
determining a systemic failure based on the difference between the observation and the expected observation of the robot exceeding a threshold value, the operations further comprising instructing the robot to transition to a non-operative state responsive to the systemic failure being determined.

14. The non-transitory computer-readable medium of claim 13, the operations further comprising providing a fault message to an external device indicating a systemic failure has been detected responsive to the systemic failure being determined.

15. The non-transitory computer-readable medium of claim 14, the operations further comprising transmitting the fault message to the external device.

16. The non-transitory computer-readable medium of claim 13, the operations further comprising causing the robot to operate according to an operative state based on the difference between the observation and the expected observation not exceeding the threshold value.

17. A system, comprising:
means to receive sensor data representative of an environment comprising a robot;
means to extract features from the sensor data to generate an extracted feature set indicating an observation of the robot within the environment;
means to generate a feature set indicating an expected observation of the robot within the environment based on pre-defined parameters of the robot;
means to determine a difference between the observation and the expected observation of the robot; and
means to determine a systemic failure based on the difference between the observation and the expected observation of the robot exceeding a threshold value, the system further comprising means to instruct the robot to transition to a non-operative state responsive to the systemic failure being determined.

18. The system of claim 17 further comprising means to provide a fault message to an external device indicating a systemic failure has been detected responsive to the systemic failure being determined.

19. The system of claim 18 further comprising means to transmit the fault message to the external device.

20. The system of claim 17 further comprising means to cause the robot to operate according to an operative state based on the difference between the observation and the expected observation not exceeding the threshold value.
